(19) United States
(12) Patent Application Publication
(10) Pub. No.: US 2013/0313280 A1
(43) Pub. Date: Nov. 28, 2013

(54) DISPENSING DEVICE

(71) Applicants: HONG FU JIN PRECISION INDUSTRY (WUHAN) CO., LTD, Wuhan (CN); HON HAI PRECISION INDUSTRY CO., LTD, New Taipei (TW)

(72) Inventors: YUN-LUNG CHEN, New Taipei (TW); CHIN-WEN YEH, New Taipei (TW); DUN-JUN ZHOU, Wuhan (CN)

(73) Assignees: HON HAI PRECISION INDUSTRY CO., LTD., New Taipei (TW); HONG FU JIN PRECISION INDUSTRY (WUHAN) CO., LTD., Wuhan (CN)

(21) Appl. No.: 13/792,208

(22) Filed: Mar. 11, 2013

(30) Foreign Application Priority Data
May 24, 2012 (CN) 201210163772.8

(51) Int. Cl. G07F 11/42

(52) U.S. Cl. CPC G07F 11/42
USPC 221/279

(57) ABSTRACT

A dispensing device includes a rigid coil, a mounting member, and a motor. The rigid coil includes a helical portion, a proximal end, and a connecting portion connecting the proximal end to the helical portion. The helical portion includes a plurality of resilient spiral coils. Each adjacent two of the plurality of resilient spiral coils configured for clamping a product. The mounting member defines a latching slot and an inserting slot along an axial direction, and further defines a securing slot along a redial direction. The motor includes a rotating shaft. The proximal end is engaged in the latching slot. The connecting portion is engaged in the securing slot. The rotating shaft is inserted in the inserting slot. The rotating shaft is rotatable along the axial direction to rotate the rigid coil through the mounting member. The helical portion is rotatable to push the product out of a product channel.

### BACKGROUND

1. Technical Field

The present disclosure relates to dispensing devices, and particularly to a product dispensing device in a vending machine.

2. Description of Related Art

In many vending machines, the dispensing assembly includes a rigid coil and a motor. The motor rotates the coil causing products to be pushed along a channel to eventually drop into a bin accessible by a customer of the vending machine. Generally, each vending machine includes more than 6 partitions, each frame includes more than 8 channels, and each channel secures one dispensing assembly. Each dispensing assembly further includes a mounting member. The mounting member secures the motor to the partition and defines a slot. The proximal end of the coil is inserted in the slot, so that the coil is secured to the motor via the mounting member. However, the proximal end can easily rotate in the slot. Thus, a support is necessary to secure the proximal end to the mounting member and prevent the proximal end from rotating relative to the mounting member. However, the support increase costs of the dispensing assembly and causes more complexity in the assembly process of the dispensing assembly. Therefore, there is room for improvement in the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an exploded, isometric view of one embodiment of a dispensing device.

FIG. 2 is similar to FIG. 1, but viewed from a different aspect.

FIG. 3 is a cross sectional view of a mounting member along an axial direction of the dispensing device of FIG. 1.

FIG. 4 is a cross-sectional view of the mounting member along a radial direction of the dispensing device of FIG. 1.

FIG. 5 is an enlarged view of a circled portion V of the dispensing device of FIG.1.

FIG. 6 is an assembled, isometric view of the dispensing device of FIG. 1.

FIG. 7 is a cross-sectional view of the assembled dispensing device of FIG. 6, taken along a line VII-VII therein.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

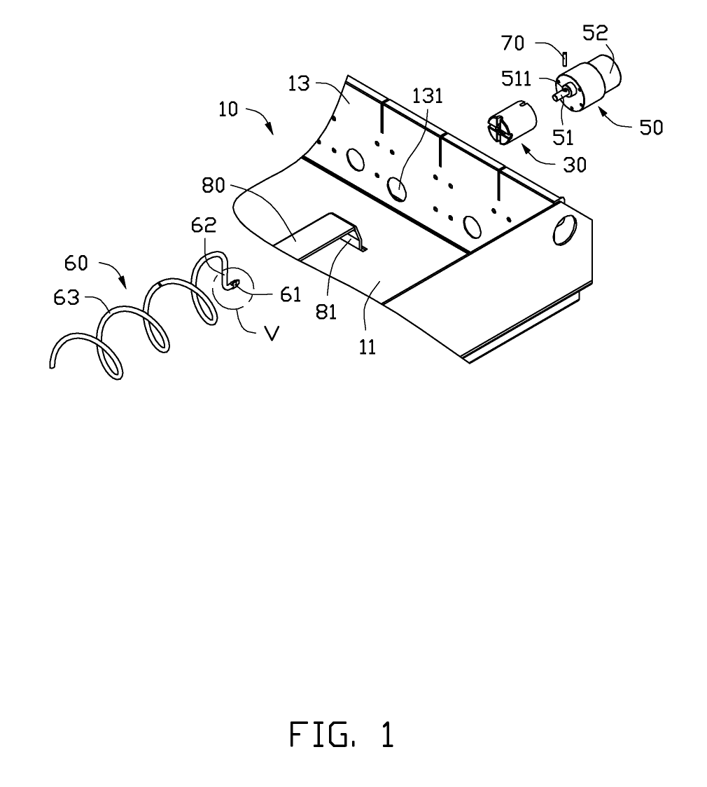

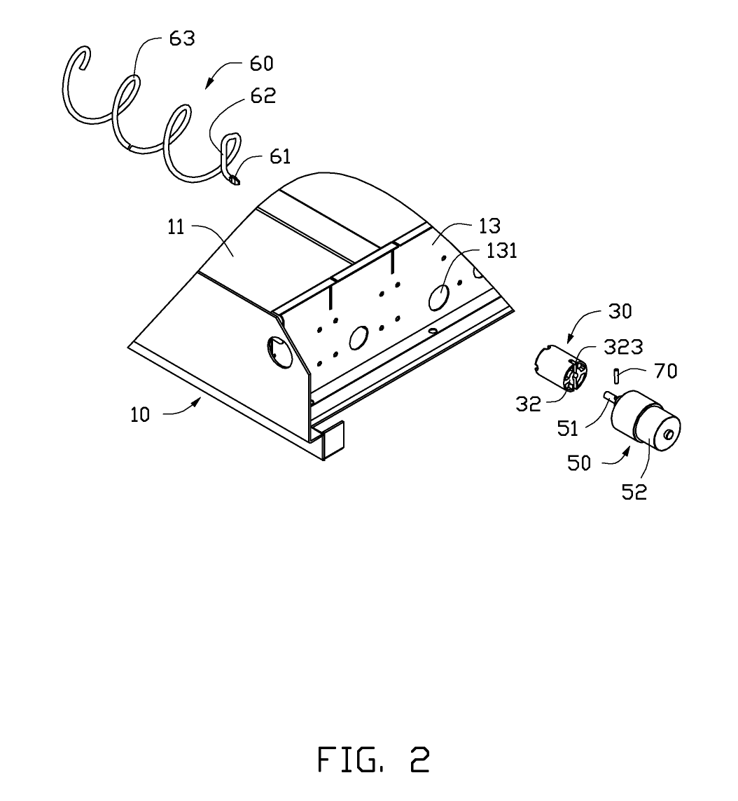

Referring to FIG. 1 and FIG. 2, a dispensing device in accordance with an embodiment is shown. The dispensing device includes a frame 10, a mounting member 30, a motor 50, and a rigid coil 60.

The frame 10 includes a bottom plate 11 and a substantially perpendicular side plate 13 secured to the bottom plate 11. A support member 80 is secured to the bottom plate 11. The support member 80 includes two securing ends 81 secured to the bottom plate 11 (only one of the two securing ends 81 is shown in FIG. 1). The side plate 13 defines a receiving hole 131 for receiving the motor 50.

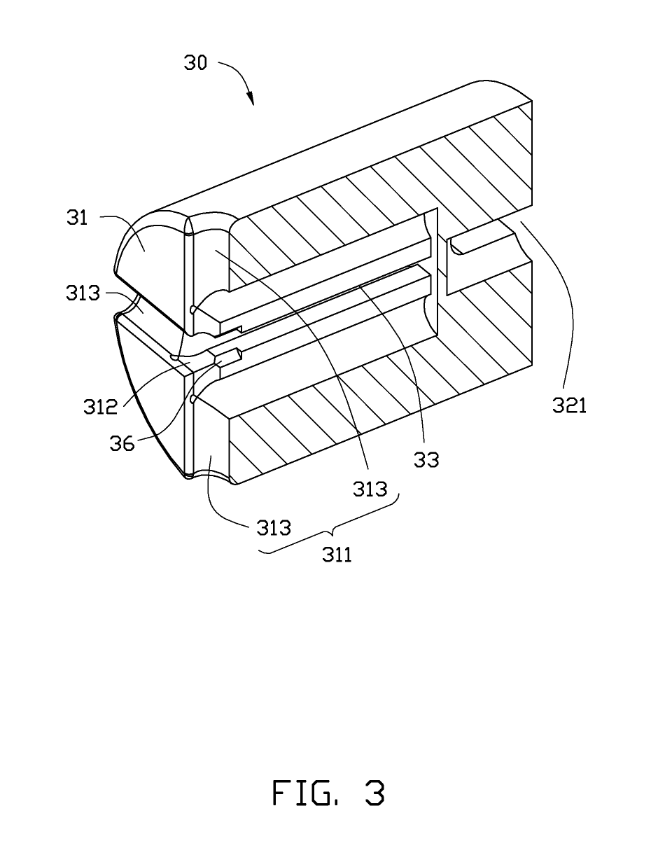

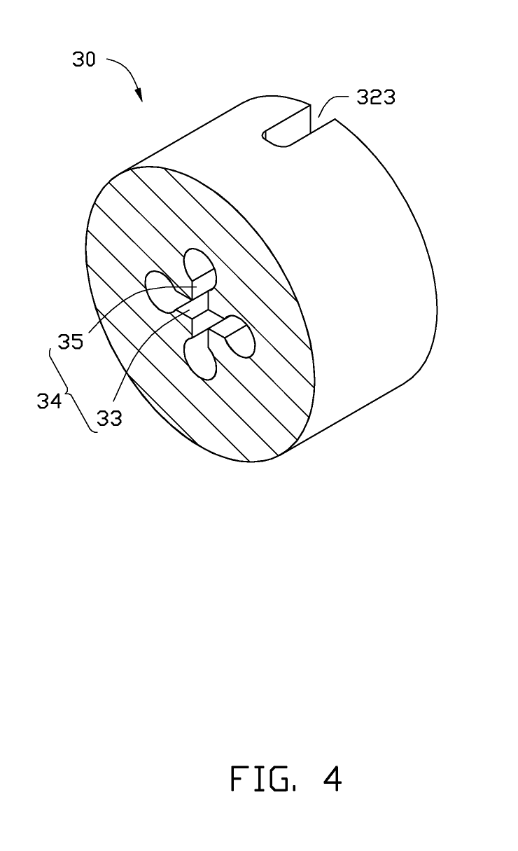

Referring to FIG. 3 and FIG. 4, the mounting member 30 is cylindrical and includes a first flat end surface 31 and a second flat end surface 32, which is substantially parallel to the first flat end surface 31. The first flat end surface 31 defines two diametric securing slots 311. The two securing slots 311 are substantially perpendicular to and communicate with each other. The two securing slots 311 have an intersection 312. The intersection 312 serves to divide the two securing slots 312 into four receiving slots 313. The mounting member 30 defines a latching slot 34 along an axial direction. The latching slot 34 includes a first latching slot 33 and a second latching slot 35 communicating with the first latching slot 33. In one embodiment, the first latching slot 33 is substantially perpendicular to the second latching slot 35. The second flat end surface 32 defines an axial inserting slot 321 and a radial mounting slot 323. The inserting slot 321 is substantially perpendicular to the mounting slot 323. The mounting member 30 further defines a cutout 36 in each corner between the first latching slot 33 and the second latching slot 35. In one embodiment, each securing slot 311 is semicircular in profile, the cutout 36 is curved, and a section of the latching slot 34 across its length is the shape of a “addition” symbol (cruciform) or “X” shaped.

The motor 50 includes a rotating shaft 51 and a driving portion 52. The rotating shaft 51 defines a through hole 511. A pivoting shaft 70 is inserted in the through hole 511 to securely engage with the rotating shaft 51.

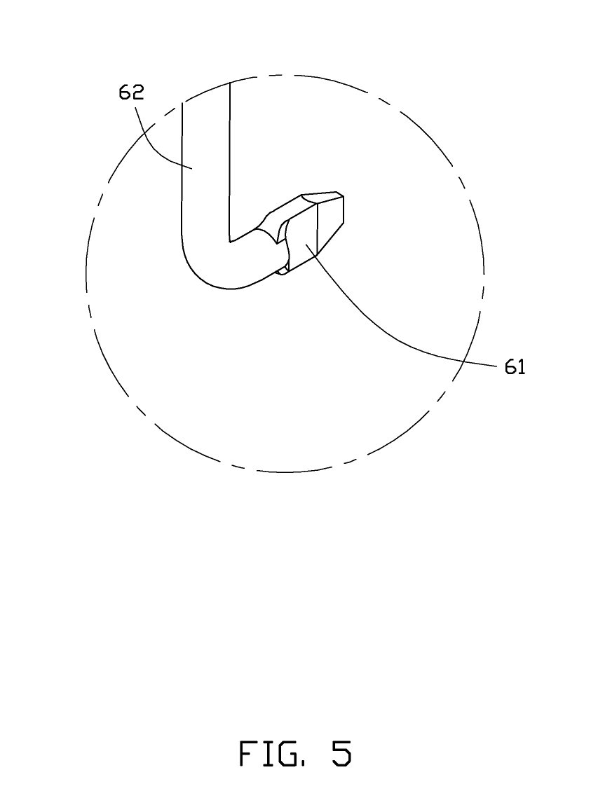

Referring to FIG. 5, the rigid coil 60 includes a proximal end 61, a connecting portion 62, and a helical portion 63. The proximal end 61 is shaped so as to be flat. A cross section of the helical portion 63 is circular. The helical portion 63 includes a plurality of helical coils, and each adjacent helical coils of the plurality of helical coils holds a product. In one embodiment, a section of the shaped proximal end 61 across its length has substantially the same shape as the tip of a crosshead screwdriver (rectangular) or line shaped.

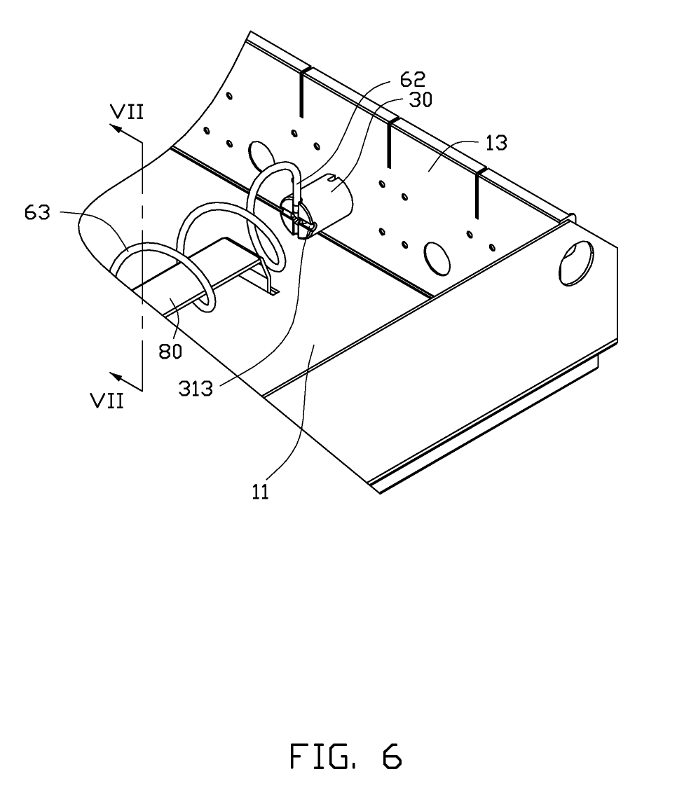

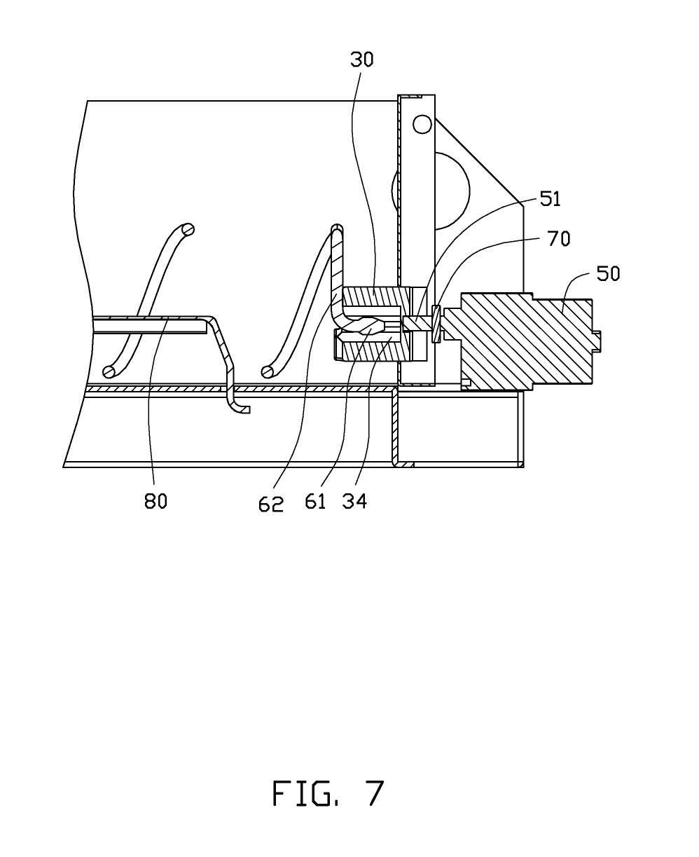

Referring to FIG. 6 and FIG. 7, in assembly, the mounting member 30 is positioned inside of the frame 10 and adjacent to the side plate 13. The mounting member 30 is engaged in the receiving hole 131, and the second flat end surface 32 extends out of the receiving hole 131. The motor 50 is positioned outside of the frame 10 and adjacent to the side plate 13. The rotating shaft 51 is inserted into the inserting slot 321, and the pivoting shaft 70 is engaged in the mounting slot 323. Thereby, the motor 50 is secured to the mounting member 30. In this position, the driving portion 52 can rotate the rotating shaft 51, and the rotating shaft 51 can rotate the mounting member 30 in the receiving hole 131, via the pivoting shaft 70. The helical portion 63 surrounds the support member 80. The proximal end 61 is engaged in the latching slot 34 through the intersection 312. The connecting portion 62 is engaged in any one of the four receiving slots 313. An internal corner between the connecting portion 62 and the proximal end 61 abuts the edges of the cutout 36. In this way, the rigid coil 60 is secured to the mounting member 30 and held in one plane of rotation, and the proximal end 61 may be secured parallel to, or perpendicular to, the bottom plate 11. When the flatmost part of the proximal end 61 is substantially perpendicular to the bottom plate 11, the connecting portion 62 is engaged in the receiving slot 313 substantially perpendicular to the bottom plate 11, and the proximal end 61 is engaged in the second latching slot 35. When the flatmost part of the proximal end 61 is substantially parallel to the bottom plate 11, the connecting portion 62 is engaged in the receiving slot 313 substantially parallel to the bottom plate 11, and the proximal end 61 is engaged in the first latching slot 33.

In use, the driving portion 52 rotates the rotating shaft 51, the rotating shaft 51 rotates the mounting member 30 and thus the rigid coil 60 rotates via the pivoting shaft 70. The rigid coil 60 moves vending products along the bottom plate 11 to the delivery tray by the action of the helical portion 63.

In another embodiment, the proximal end 61 is cruciform or “X” shaped.

It is to be understood, however, that even though numerous characteristics and advantages have been set forth in the foregoing description of embodiments, together with details of the structures and functions of the embodiments, the disclosure is illustrative only and changes may be made in detail, especially in the matters of shape, size, and the arrangement of parts within the principles of the disclosure, to the full extent indicated by the broad general meaning of the terms in which the appended claims are expressed.

What is claimed is:

1. A dispensing device, comprising:
a rigid coil comprising a helical portion, a proximal end, and a connecting portion connecting the proximal end to the helical portion, the helical portion comprising a plurality of resilient spiral coils, each adjacent resilient spiral coils of the plurality of resilient spiral coils being configured for securing a product;
a mounting member defining a latching slot and an inserting slot along an axial direction, and further defining a securing slot along a redial direction; and
a motor comprising a rotating shaft;
wherein the proximal end is engaged in the latching slot; the connecting portion is engaged in the securing slot; the rotating shaft is inserted in the inserting slot; the rotating shaft is rotatable along the axial direction to rotate the rigid coil through the mounting member; and the helical portion is rotatable to push the product out of a product channel.

2. The dispensing device of claim 1, wherein the securing slot is substantially cruciform, and the connecting portion is capable of being received in the securing slot along four directions.

3. The dispensing device of claim 1, wherein the proximal end is flat, the latching slot is substantially cruciform, and the proximal end is capable of engaging in the latching slot along four directions.

4. The dispensing device of claim 1, wherein the mounting member comprises a first flat end surface and a second flat end surface opposite to the first flat end surface; the securing slot is defined in the first flat end surface, and the securing slot communicates with the latching slot; the proximal end is inserted in the latching slot through the securing slot; and the inserting slot extends along the redial direction from the second flat end surface.

5. The dispensing device of claim 4, wherein the latching slot comprises a first latching slot and a second latching slot; the first latching slot is perpendicularly intersected with the second latching slot; a cutout is defined in a corner between the first latching slot and the second latching slot; and a corner between the connecting portion and the proximal end abuts edges of the cutout.

6. The dispensing device of claim 2, further comprising a pivoting shaft, wherein the second flat end surface defines a mounting slot along the redial direction; the pivoting shaft is secured to the rotating shaft and engaged in the mounting slot.

7. The dispensing device of claim 1, wherein a longitudinal section of the proximal end is substantially rectangular.

8. The dispensing device of claim 7, wherein the longitudinal section of the proximal end is substantially cruciform.

9. The dispensing device of claim 1, further comprising a support member, wherein the helical portion surrounds the support member.

10. A dispensing device, comprising:
a rigid coil comprising a helical portion, a proximal end, and a connecting portion connecting the proximal end to the helical portion, the helical portion comprising a plurality of resilient spiral coils, each adjacent resilient spiral coils of the plurality of resilient spiral coils being configured for securing a product;
a mounting member defining a latching slot and an inserting slot along an axial direction, and further defining a securing slot along a redial direction; and
a motor comprising a rotating shaft;
wherein the proximal end is engaged in the latching slot; the connecting portion is engaged in the securing slot; the rotating shaft is inserted in the inserting slot; the rotating shaft is rotatable along the axial direction to rotate the rigid coil through the mounting member; and the helical portion is rotatable to push the product out of a product channel; and the latching slot is substantially cruciform, and the proximal end is capable of engaging in the latching slot along four directions.

11. The dispensing device of claim 10, wherein the securing slot is substantially cruciform, and the connecting portion is capable of being received in the securing slot along four directions.

12. The dispensing device of claim 10, wherein the latching slot comprises a first latching slot and a second latching slot; the first latching slot is perpendicularly intersected with the second latching slot; a cutout is defined in a corner between the first latching slot and the second latching slot; and a corner between the connecting portion and the proximal end abuts edges of the cutout.

13. The dispensing device of claim 10, wherein the mounting member comprises a first flat end surface and a second flat end surface opposite to the first flat end surface; the securing slot is defined in the first flat end surface; the proximal end is inserted in the latching slot through the securing slot; and the inserting slot extends long the redial direction from the second flat end surface.

14. The dispensing device of claim 13, further comprising a pivoting shaft, wherein the second flat end surface defines a mounting slot along the redial direction; the pivoting shaft is secured to the rotating shaft and engaged in the mounting slot.

15. The dispensing device of claim 10, wherein the proximal end is flat.

16. The dispensing device of claim 10, wherein a longitudinal section of the proximal end is substantially rectangular.

17. The dispensing device of claim 16, wherein the longitudinal section of the proximal end is substantially cruciform.

18. The dispensing device of claim 10, further comprising a support member, wherein the helical portion surrounds the support member.
